(19) United States
(12) Patent Application Publication
(10) Pub. No.: US 2011/0302595 A1
(43) Pub. Date: Dec. 8, 2011

(54) Workspace CD Holder

(76) Inventor: Timothy Michael Kennedy, Rocky Hill, CT (US)

(21) Appl. No.: 12/986,306

(22) Filed: Jan. 7, 2011

Related U.S. Application Data
(60) Provisional application No. 61/397,234, filed on Jun. 8, 2010.

(51) Int. Cl. G11B 23/03

(52) U.S. Cl. 720/719; G9B/23.02

(57) ABSTRACT

A workspace CD organizer. The organizer includes an elongated strip supporting base with a bent around the middle, and a spindle vertically perpendicularly mounted on the supporting base for holding multiple CDs. The base strip has sufficient thickness to avoid a CD from touching other surface and being scratched.

### CROSS REFERENCE

This application claims the benefit of the U.S. Provisional Application No. 61/397,234 filed on Jun. 8, 2010, the entirety of which is thereby incorporated by reference.

### DESCRIPTION OF RELATED ART

The present application relates to a compact disc organizer, and more particularly to a temporary compact disc organizer for using in the workspace to organize and hold a discs temporarily.

Note that the points discussed below may reflect the hindsight gained from the disclosed inventions, and are not necessarily admitted to be prior art.

Compact discs (CDs) have been used for the storage of data, movies, music, games, software, and other media-related contents. But compact discs can be very easily scratched and damaged. Many complicated efforts have been made to provide storage and organization of compact discs. For example, US Patent Application No. 2004/0169446 A1 discloses an organization kit that contains multiple CD storage cases stacking together. The cases have a base and a top hinged with hinge tabs.

Another example is U.S. Pat. No. 6,588,609 B1 which discloses a cylindrical rotatable storage device that is placed underneath a monitor. The structure is sufficiently complicated that it is divided into several storage compartments having varying shapes.

US Patent Application No. 2009/0314670 A1 attempted to simplify the design by disclosing a spindled package tray for holding plurality of discs. However, the tray still includes a multi-layer structure: a depression, a spindle, and multiple holes and a cover.

Associated with these complicated design structures are the higher cost for purchasing and replacing such devices. They may not be suitable and convenient for temporary storage of CDs in a workspace where multiple CDs may be repeatedly played or used in several days or weeks.

### SUMMARY

The present application discloses a novel and simple design for temporary storage and protection of CDs in workspace for easy access and convenience for repeated play and access.

In an example embodiment, the CD organizer includes a spindle and a stable base. The base is a shape that provides sufficient stability with the spindle holding plurality of CDs.

In one aspect of embodiment, the base is of an elongated “J” shape with a wide angle, with the spindle vertically perpendicular to the base at the junction. The spindle is of cylindrical shape with a diameter smaller than the central hole of a CD.

Such a dramatically simpler CD holder provides cost efficiency and easy to use advantage than any other complicated designs. Users can simply place such CD organizer on the desk or the top of a gaming device, for temporary holding of CDs that are being repeatedly played in this period of time.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 shows a perspective view of an example CD holder in accordance with this application.

FIG. 2A shows a top view of an example CD holder in accordance with this application.

FIG. 2B shows a side view of an example CD holder in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

In a game room or living room, most people have their favorite game or music CDs or movie CDs to play repeatedly. Or sometimes, people just want to try out some new games or movies without having to place them back to storage. The situation could become messy when multiple CDs are taking out to try. Without an organizer, these CDs may be scratched and damaged. The disclosed design provides such a CD organizer for a workspace to temporarily hold these CDs for trying out.

It is contemplated and intended that the disclosed design be made of any suitable material, preferably plastic. Other material may include metal, wood, rubber, glass, stone, and plexiglass (i.e. acrylic plastic resin), etc.

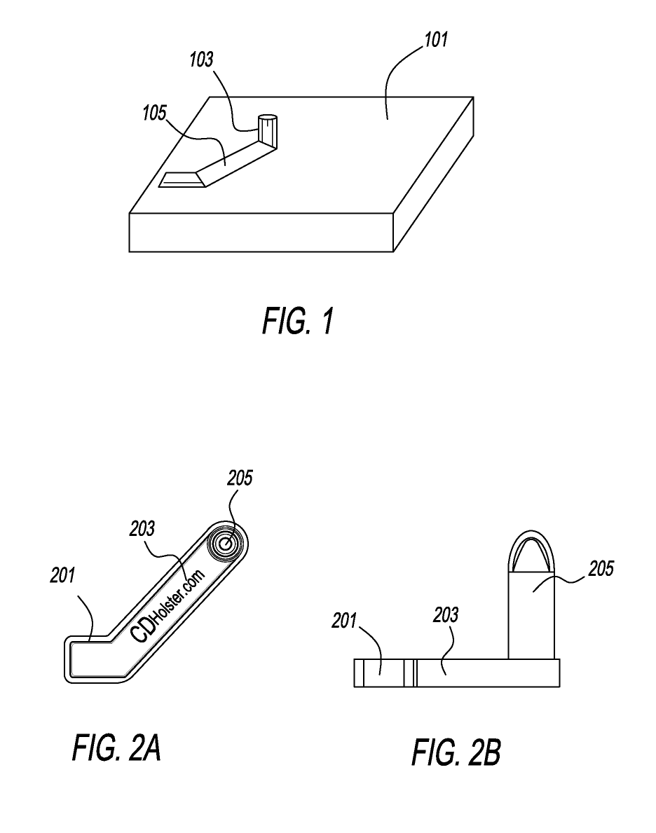

In reference to FIG. 1, a workspace CD organizer simply includes a supporting strip base 105 with an elongated body and perpendicular spindle 103. Spindle 103 is configured to have sufficient length for holding multiple CDs. The base 105 is configured to be large enough to stand stable when spindle 103 holds a plurality of CDs through the CDs' central holes. The organizer may be placed on top of an electronic game player 101, or any flat surface of a gadget. Preferably base 105 takes a shape of flat “hockey stick” with sufficient thickness to prevent a CD from touching surface 101.

In reference to FIG. 2A, a top view of an example workspace CD organizer shows a base having a bend with elongation flat stretch 203 and 201 forming an obtuse angle with each other. In reference to FIG. 2B, a side view of an example workspace CD organizer shows a spindle 205 vertically perpendicular to the base 201 and 203, with a diameter that is smaller than the central hole of a CD. Spindle 205 therefore conveniently holds any CD temporarily in a workspace by inserting into the central hole of the CD. The CD can easily be repeatedly accessed from the Spindle without much hassle, and without being scratched.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the US Patent Application No. 2009/0314670 A1, the entirety of which is hereby incorporated by reference herein for all purposes.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A spindle CD organizer for workspace, comprising:
a flat base having an elongated body with a bent and a sufficient thickness for preventing a compact disc from touching other surface; and
a spindle vertically perpendicular to said flat base, fixedly mounted on said flat base, for holding said compact disc through a central hole on said disc.

2. The spindle CD organizer of claim 1, wherein said flat base has a first end and a second end along the elongated body, said spindle is mounted on first end of said flat base.

3. The spindle CD organizer of claim 1, wherein said flat base has a middle point along the elongated body, and said spindle is mounted around the middle point.

4. The spindle CD organizer of claim 1 is made of metal.

5. The spindle CD organizer of claim 1 is made of plastic.

6. The spindle CD organizer of claim 1 is made of stone.

7. The spindle CD organizer of claim 1 is made of glass.

8. The spindle CD organizer of claim 1 is made of acrylic plastic resin.
